(19) United States
(12) Patent Application Publication
(10) Pub. No.: US 2017/0091856 A1
(43) Pub. Date: Mar. 30, 2017

(54) VEHICLE DELIVERY THROUGH A MOBILE COMPUTING DEVICE

(71) Applicant: Skurt, Inc., Los Angeles, CA (US)

(72) Inventors: Ilteris Kaan Canberk, Los Angeles, CA (US); Harry Hurst, Los Angeles, CA (US); Joshua Stanley Mangel, Los Angeles, CA (US)

(21) Appl. No.: 15/279,124

(22) Filed: Sep. 28, 2016

Related U.S. Application Data
(60) Provisional application No. 62/233,865, filed on Sep. 28, 2015.

(51) Int. Cl. G06Q 30/06; H04W 12/12; G06Q 10/02; H04W 4/02

(52) U.S. Cl. CPC G06Q 30/0645; H04W 4/02; H04W 12/12; G06Q 10/02; G06Q 30/0609; H04W 88/02

(57) ABSTRACT

A system includes at least one processor to receive a vehicle reservation request comprising a vehicle delivery location, a start time, an end time, and a vehicle type from a mobile computing device, determine an appropriate vehicle for the vehicle reservation request from a plurality of vehicles, the appropriate vehicle selected based on a location of each of the plurality of the vehicles, the vehicle delivery location, a current fuel/energy level for each of the plurality of vehicles, an availability of each of the plurality of vehicles having the vehicle type between the start time and the end time, and traffic information, and dispatch the appropriate vehicle to arrive at the vehicle delivery location at the start time.

### CROSS-REFERENCE TO RELATED APPLICATIONS

This application is related to and claims priority under 35 U.S.C. §119(e) to U.S. Patent Application No. 62/233,865, filed Sep. 28, 2015, entitled “Vehicle Delivery Through a Mobile Computing Device,” the entire contents of which are incorporated herein by reference.

### BACKGROUND

Computing devices have gradually become ubiquitous and a part of daily life. Users of smartphones and tablets have access to a portable device that is capable of communicating with others, capable of executing applications, and capable of sending information to other devices and receiving information from other devices.

It has become common practice for a user to utilize an online travel agency (OTA) website or a car rental agency website to make a car rental reservation. A user may reserve a vehicle at a particular location/airport, travel to the particular location/airport via air travel, and make their way to a car rental agency kiosk at or near the particular location/airport. The user may have to board a car rental shuttle with a large amount of luggage and wait in a line at the car rental agency kiosk. Upon arrival at the kiosk, the user may have to wait for the vehicle to be ready, may be encouraged to obtain insurance and/or prepaid expensive gasoline, may have to pay a premium based on their age, and eventually locate the vehicle in a large, dimly parking lot or garage. In addition, employees of the car rental agency kiosk are encouraged to upsell other aspects of the car rental and often provide poor customer service. This process may be an exhausting, exasperating, hours-long process. Renting a vehicle is expensive, difficult, burdensome, time-consuming, and annoying.

It is with these issues in mind, among others, that various aspects of the disclosure were conceived.

### SUMMARY

According to one aspect, a vehicle delivery system is provided for receiving a vehicle delivery request from a computing device, determining an appropriate vehicle based on the vehicle request, and dispatching the appropriate vehicle to a location associated with the vehicle request. In another aspect, a vehicle delivery system is provided for receiving a vehicle return request from a computing device, determining an appropriate return location based on the vehicle return request, and returning a vehicle to the particular return location based on the vehicle return request.

According to one embodiment, a system includes at least one processor to receive a vehicle reservation request comprising a vehicle delivery location, a start time, an end time, and a vehicle type from a mobile computing device, determine an appropriate vehicle for the vehicle reservation request from a plurality of vehicles, the appropriate vehicle selected based on a location of each of the plurality of the vehicles, the vehicle delivery location, a current fuel/energy level for each of the plurality of vehicles, an availability of each of the plurality of vehicles having the vehicle type between the start time and the end time, and traffic information, and dispatch the appropriate vehicle to arrive at the vehicle delivery location at the start time.

According to a further embodiment, a method includes receiving, by at least one processor, a vehicle reservation request comprising a vehicle delivery location, a start time, an end time, and a vehicle type from a mobile computing device, determining, by the at least one processor, an appropriate vehicle for the vehicle reservation request from a plurality of vehicles, the appropriate vehicle selected based on a location of each of the plurality of the vehicles, the vehicle delivery location, a current fuel/energy level for each of the plurality of vehicles, an availability of each of the plurality of vehicles having the vehicle type between the start time and the end time, and traffic information, and dispatching, by the at least one processor, the appropriate vehicle to arrive at the vehicle delivery location at the start time.

According to another embodiment, a non-transitory computer-readable medium includes instructions stored thereon that, when executed by at least one processor, causes the at least one processor to perform operations including receiving a vehicle reservation request comprising a vehicle delivery location, a start time, an end time, and a vehicle type from a mobile computing device, determining an appropriate vehicle for the vehicle reservation request from a plurality of vehicles, the appropriate vehicle selected based on a location of each of the plurality of the vehicles, the vehicle delivery location, a current fuel/energy level for each of the plurality of vehicles, an availability of each of the plurality of vehicles having the vehicle type between the start time and the end time, and traffic information, and dispatching the appropriate vehicle to arrive at the vehicle delivery location at the start time.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a block diagram of a vehicle delivery system according to an example embodiment.

FIG. 2 illustrates a block diagram of a client computing device according to an example embodiment.

FIG. 3 illustrates a block diagram of a server computing device of the system according to an example embodiment.

FIG. 4 illustrates a database table of the system according to an example embodiment.

FIG. 5 illustrates a flowchart for receiving and processing a vehicle delivery request according to an example embodiment.

FIG. 6 illustrates a flowchart for receiving and processing a vehicle return request according to an example embodiment.

FIGS. 7-10 illustrate example screenshots of user interfaces of a vehicle delivery application according to an example embodiment.

FIG. 11 illustrates a block diagram of an example computer device for use with the example embodiments.

### DETAILED DESCRIPTION

For the purpose of promoting an understanding of the principles of the present disclosure, reference will now be made to the embodiments illustrated in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

The client computing devices and the server computing device communicate over a communications network using Hypertext Transfer Protocol (HTTP) and/or other communications protocols. HTTP provides a request-response protocol in the client-server computing model. A client application running on the client computing device may be a client and a server application running on the server computing device may be the server, e.g., a web server. The client submits, for example, an HTTP request to the server. The web server of the server computing device provides resources, such as Hypertext Markup Language (HTML) files and/or other content, and performs other functions on behalf of the client, and returns an HTTP response message to the client. Other types of communications using different protocols may be used in other examples.

The one or more computing devices may communicate based on representational state transfer (REST) and/or Simple Object Access Protocol (SOAP). As an example, a first computer (e.g., a client computer) may send a request message that is a REST and/or a SOAP request formatted using Javascript Object Notation (JSON) and/or Extensible Markup Language (XML). In response to the request message, a second computer (e.g., a server computer) may transmit a REST and/or SOAP response formatted using JSON and/or XML.

Aspects of a system and method for vehicle delivery provide a client application for creating a vehicle delivery request or a vehicle return request and submitting the vehicle delivery request or the vehicle return request to a server. The server receives the vehicle delivery request or the vehicle return request and a server application processes the vehicle delivery request or the vehicle return request.

For example, a user, e.g., a renter, may request a vehicle using the client application. The client application may transmit a request to the server application. The server application receives the request, processes the request, determines a particular vehicle for the request from a plurality of vehicles, and dispatches the particular vehicle to a location associated with the user, which may be a location of a smartphone or another computing device. The client application may be executed by the smartphone and the vehicle may be a rental vehicle.

In another example, a user may send a vehicle return request using the client application. The client application may transmit the vehicle return request to the server application. The server application receives the request, processes the request, and sends a message with information regarding the vehicle return request to a computing device of a third party provider instructed to pick up a vehicle and return the vehicle to an appropriate return location.

Optionally, the vehicle may be an autonomous vehicle or a partially autonomous vehicle. In one example, the vehicle may receive messages from the server including locations. In another example, the vehicle may travel to a location associated with the smartphone. In another example, the vehicle may travel from the location associated with the smartphone to the appropriate return location.

Each vehicle of the plurality of vehicles may be owned by a company/provider, such as a rental company, and/or individual owners that allow users to rent and use the vehicle. Using a mobile computing device, such as a smartphone, a smartwatch, or another geoaware device, a user may select a vehicle, verify their identity, sign agreements, and send a vehicle reservation request to a server computing device using a vehicle delivery application. When the reservation is received by the server computing device, the vehicle may be sourced from a specific company/provider or individual based on the requested rental delivery location provided by the user. The provider or individual may accept the reservation request to fulfill the request or may deny the reservation request. Once the reservation is accepted, the vehicle may be transported to the rental location by a third party provider or autonomously without human intervention. The vehicle is left with the user and the user has exclusive access to the vehicle during a reservation period.

Before the user is allowed to reserve a vehicle, the user may provide identity information that is analyzed by the server computing device and/or other computing devices to verify the identity of the user. After the identity of the user is verified, the user may use a selected payment method to reserve the vehicle. The user may select any insurance preferences using the vehicle delivery application and may sign any agreements associated with the reservation using the vehicle delivery application. After the user signs the agreements, reservation information is sent to the provider or individual and the provider or the individual may arrange delivery of the vehicle to the rental location at the time requested by the user.

The reservation period may be modified/extended using the vehicle delivery application. The user may select a delivery location, a time period for the reservation, and a specific vehicle or a specific vehicle type using the vehicle delivery application.

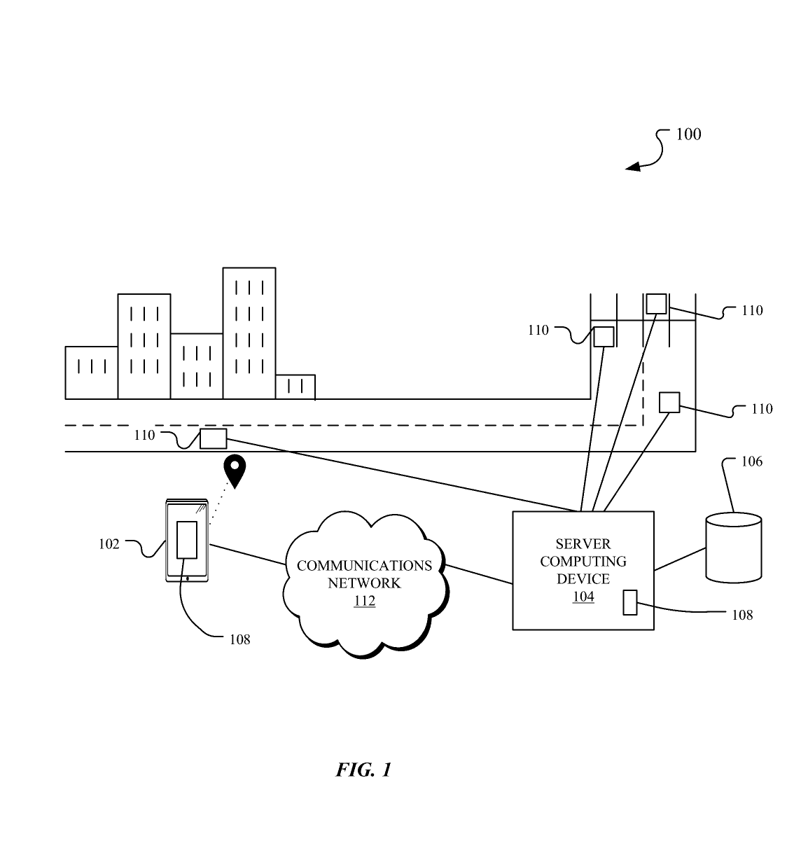

FIG. 1 shows a block diagram of a computing system that includes a vehicle delivery system 100 according to an example embodiment. The vehicle delivery system 100 includes at least one client computing device 102 that is in communication with at least one server computing device 104 via a communications network 112. In addition, the vehicle delivery system 100 includes a plurality of vehicles 110 that are in communication with the server computing device 104 via the communications network 112. The vehicle 110 may be a machine that transports people and/or cargo including a terrestrial motor vehicle, a watercraft, and an aircraft, among other vehicles.

The at least one client computing device may have a client component of a vehicle delivery application 108 and the at least one server computing device 104 may have a server component of the vehicle delivery application 108 that communicates with at least one database 106 that comprises a non-relational database and/or a relational database for storing vehicle information and user information, among other data. As an example, the information may be stored in a relational database management system (RDBMS), an open source distributed database management system such as a Not only SQL (NoSQL) database management system, an in-memory database (IMDB) management system, or another appropriate database management system. As an example, each vehicle 110 associated with the system 100 may have associated information stored in the database 106 and each user of the system may have associated information stored in the database 106.

As an example, vehicle reservations may be stored in a first table of the database 106, vehicle locations may be stored in a second table of the database 106, and user account information (e.g., username/password information) may be stored in a third table of the database 106. Other tables may store additional information such as vehicle information and driver information, among other information. Each vehicle reservation may have a particular identifier that is used to reference the vehicle reservation in the database 106. In addition, each vehicle 110 may have a particular identifier that is used to reference the vehicle in the database 106. The vehicle locations of each of the vehicles 110 associated with the vehicle delivery system may be continually updated in the database 106. A vehicle location may be determined using one of a location of the vehicle 110 or a location of the client computing device 102.

The at least one server computing device 104 is configured to receive data from and/or transmit data to the at least one client computing device 102 through the communications network 112. In addition, the vehicle 110 is configured to receive data from and/or transmit data to the server computing device 104 through the communications network 112. Although the at least one server computing device 104 is shown as a single server, it is contemplated that the at least one server computing device 104 may include multiple servers, for example, in a cloud computing configuration.

The one or more computing devices communicate and coordinate their actions by passing messages over the communications network 112. The communications network 112 can be one or more of the Internet, an intranet, a cellular communications network, a WiFi network, a packet network, or another wired and/or wireless communication network or a combination of any of the foregoing. As an example, the one or more computing devices communicate data in packets, messages, or other communications using a common protocol, e.g., Hypertext Transfer Protocol (HTTP) and/or Hypertext Transfer Protocol Secure (HTTPS). As an example, the vehicle delivery system 100 may be a cloud-based computer system or a distributed computer system.

The vehicle delivery application 108 may be a component of an application and/or service executable by the client computing device 102 and/or the server computing device 104. For example, the vehicle delivery application 108 may be a single unit of deployable executable code or a plurality of units of deployable executable code. According to one aspect, the vehicle delivery application 108 may be a web application, a native application, and/or a mobile application (e.g., an app) downloaded from a digital distribution application platform that allows users to browse and download applications developed with mobile software development kits (SDKs) including the App Store and GOOGLE PLAY®, among others. The vehicle delivery application 108 may be installed on the client computing device 102, which may have the iOS operating system or an ANDROID™ operating system, among other operating systems. In an exemplary embodiment, the vehicle delivery application 108 may include a first client component executed by the client computing device 102 and a second server component executed by the at least one server computing device 104.

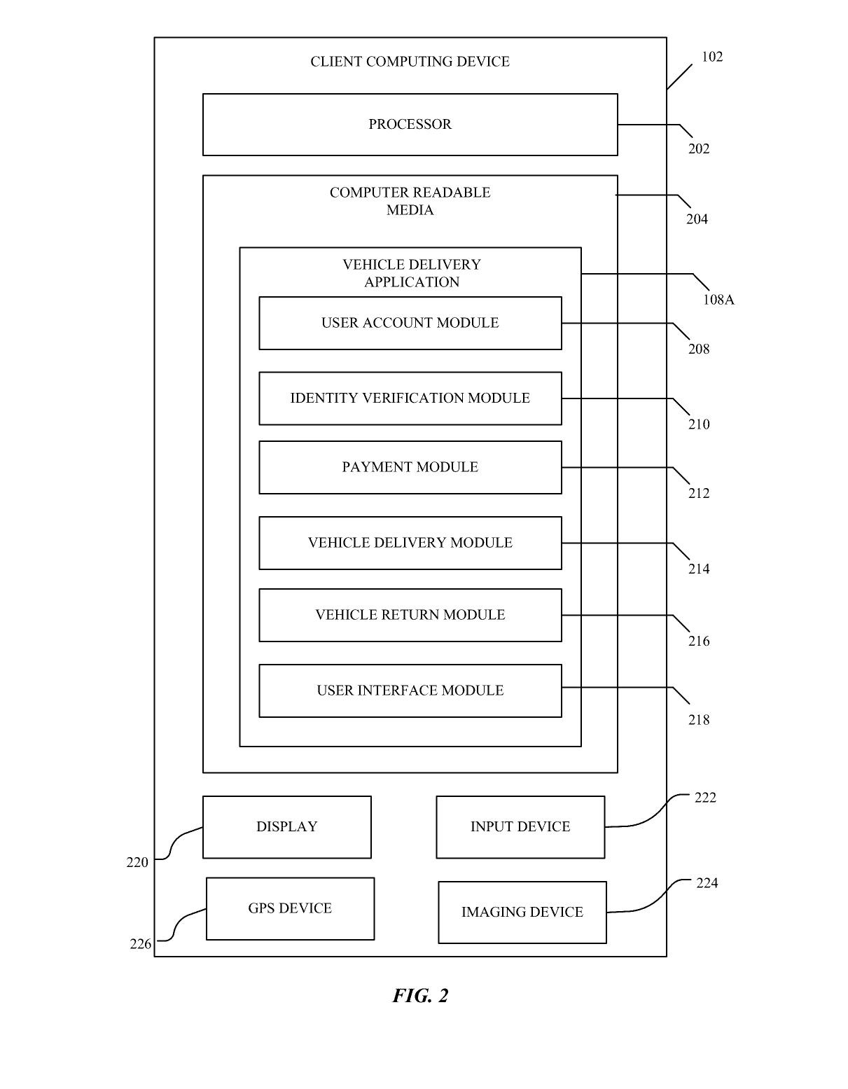

FIG. 2 illustrates a block diagram of the client computing device 102 according to an example embodiment. The client computing device 102 may be a computer having a processor 202 and memory, such as a laptop, desktop, tablet computer, mobile computing device (e.g., a smartphone), a wearable device, or a dedicated electronic device having a processor and memory. The one or more processors 202 process machine/computer-readable executable instructions and data, and the memory stores machine/computer-readable executable instructions and data including one or more applications, including a client component of the vehicle delivery application 108A. The processor 202 and memory are hardware. The memory includes random access memory (RAM) and non-transitory memory, e.g., a non-transitory computer-readable storage medium such as one or more flash storages or hard drives. The non-transitory memory may include any tangible computer-readable medium including, for example, magnetic and/or optical disks, flash drives, and the like. Additionally, the memory may also include a dedicated file server having one or more dedicated processors, random access memory (RAM), a Redundant Array of Inexpensive/Independent Disks (RAID) hard drive configuration, and an Ethernet interface or other communication interface, among other components.

The client computing device 102 uses the vehicle delivery application 108A to transmit data and messages and receive messages, data, and/or resources from the one or more server computing devices 104. The vehicle delivery application 108A provides an interface to request a vehicle 110 to rent for a period of time to be delivered to a particular location and return the vehicle to an appropriate parking location.

In order to obtain access to protected resources associated with the server computing device 104, e.g., resources stored in the database 106, the client computing device 102 optionally may transmit a request or other communication, such as with a representation of a username and a password, to the server computing device 104 using lightweight directory access protocol (LDAP), HTTP, hypertext transport protocol secure (HTTPS) and/or other protocols. The request may be a LDAP request, a representational state transfer (REST) request, a Simple Object Access Protocol (SOAP) request, or another type of request. The server computing device 104 optionally verifies the username and password and transmits a response or other communication to the client computing device 102 or otherwise grants access to the client computing device to create and view media. The server computing device 104 may transmit an HTTP response, an HTTPS response, a LDAP response, a REST response, a SOAP response, and/or another type of response.

The username and password may be encrypted by the client computing device 102 using transport layer security (TLS), secure sockets layer (SSL), and/or other encryption protocols. The username and password may be encrypted using a cryptographic hash function (e.g., SHA-1, MD5, and others) to determine a hash-based message authentication code (HMAC) (hash-based message authentication code). In one example, “username.password” is encrypted using the cryptographic hash function. This cryptographic hash function allows the username and password to be verified and authenticated by the server computing device 104 without directly sending the username and password to the server computing device via the communications network 112.

The vehicle delivery application 108A may be a component of an application and/or service executable by the client computing device 102. For example, the vehicle delivery application 108A may be a single unit of deployable executable code. The vehicle delivery application 108A may be one application and/or a suite of applications. According to an example embodiment, the vehicle delivery application 108A may be a native application or a mobile application (e.g., an app) downloaded from a digital distribution application platform that allows users to browse and download applications developed with mobile software development kits (SDKs) including the App Store and GOOGLE PLAY® among others. The app may be installed on the client computing device 102, which may have the iOS operating system or an ANDROID™ operating system, among other operating systems. The vehicle delivery application 108A communicates messages to the server computing device 104 and receives messages from the server computing device, e.g., HTTP requests and corresponding HTTP responses. The responses may comprise requested content.

The client computing device 102 further includes a display 220 and an input device 222. The display 220 is used to display visual components of the vehicle delivery application 108A, such as at a user interface. In one example, the user interface may display a user interface of the vehicle delivery application 108A, and a representation of the requested resources received from the server computing device 104. The display 220 can include a cathode-ray tube display, a liquid-crystal display, a light-emitting diode display, a touch screen display, and/or other displays. The input device 222 is used to interact with the vehicle delivery application 108A or otherwise provide inputs to the client computing device 102 and may include a mouse, a keyboard, a trackpad, and/or the like. The input device 222 may be included within the display 220 if the display is a touch screen display. The input device 222 allows a user of the client computing device 102 to manipulate the user interface of the vehicle delivery application 108A or otherwise provide inputs to be transmitted to the server computing device 104.

The client computing device 102 may include an imaging device 224, e.g., a camera for capturing video and/or still images and photographs, an optional sound device for providing audio output that may be associated with a notification provided by the server computing device 104 and received by the vehicle delivery application 108A or other user interface or application and an optional vibration motor for providing vibration feedback that may be associated with a notification provided by the server computing device 104 and received by the vehicle delivery application 108A. The client computing device 102 also may include a global positioning system (GPS) device 226 for obtaining a current location of the client computing device 102.

The client computing device 102 includes computer readable media (CRM) 204 in memory on which the vehicle delivery application 108A or other user interface or application is stored. The computer readable media may include volatile media, nonvolatile media, removable media, non-removable media, and/or another available medium that can be accessed by the processor 202. By way of example and not limitation, the computer readable media comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

The vehicle delivery application 108A includes a user account module 208 for creating a user account for use with the vehicle delivery system 100. The user account module 208 receives user account information including username information, e.g., RenterUser, password information, e.g., 1234Secret, and contact information such as an email address, among other information such as biometric information for the user. The biometric information may include a representation of a fingerprint of the user. The user account module 208 receives input from a user of the vehicle delivery application 108A and transmits the user account information to the server computing device 104 to create the user account for use with the vehicle delivery system 100.

The vehicle delivery application 108A further includes an identity verification module 210 for verifying an identity of a user of the vehicle delivery application 108A. After the user creates an account, the user may provide identity information including a first name, a last name, a physical address, an identification number/information such as a driver's license number, a passport number, and/or a social security number, and driver's license information, among other information.

As an example, the user may capture a front photograph of their driver's license and a back photograph of their driver's license using the imaging device 224. The identity verification module 210 and/or the server computing device 104 may determine the first name, the last name, the physical address, the driver's license number, and a photograph of the user by performing image analysis on the front photograph and the back photograph. The identity verification module 210 may transmit the identity information to the server computing device 104. The server computing device 104 may store a representation of the identity information in the database 106. The server computing device 104 may confirm the identity of the user before the user is permitted to rent a vehicle 110.

The vehicle delivery application 108A further includes a payment module 212 for sending a payment for reserving and/or renting a vehicle 110 to the server computing device 104. If the server computing device 104 verifies the identity of the user, then the user may input payment information such as a default payment method, e.g., a credit card, a debit card, Apple Pay®, or another payment method. The user may use the payment module 212 to input payment information to reserve/rent a vehicle 110. In one example, the user may capture a photograph of a front of a credit card and the payment module 212 may determine a credit card number and expiration date information from the photograph. The payment module 212 may transmit a representation of the payment information to the server computing device 104 for storage in the database 106.

In addition, the payment module 212 may allow the user to sign agreements and contracts. In one example, the user may sign a contract agreeing that all identity information is correct and to reserve/pay for the rental of vehicles using the vehicle delivery application 108A. The vehicle delivery application 108A may capture signature information and transmit the signature information to the server computing device 104 for storage in the database 106. The signature information may include a representation of a signature captured by the touchscreen of the client computing device 102.

The vehicle delivery application 108A further includes a vehicle delivery module 214 for sending a vehicle rental request reservation to the server computing device 104. In one example, the user, e.g., a renter, may enter rental information about a particular upcoming rental reservation including a vehicle delivery location such as a current location or another location. The vehicle delivery application 108A may determine a current location of the client computing device 102 using the GPS device 226.

In addition, the user may provide a rental start date/time and a rental end date/time and/or a delivery window of thirty minutes or more. The user may select a particular vehicle type or level such as solid, large, plus, and utility, and a vehicle classification/size such as midsize, fullsize, and lux among others. As an example, a solid midsize may be a Toyota® Corolla, a solid fullsize may be a Toyota® Camry, and a solid lux may be a Mercedes-Benz® CLA. A large standard may be a Toyota® Rav4, a large fullsize may be a Ford® Explorer, and a large minivan may be a Toyota® Sienna. A plus vehicle may include a Ford® Mustang, a Volkswagen® Beetle, and a Toyota® Prius. A utility truck may include a Ford® F-150, a utility cargo may include a Ford® Transit van, and a utility fifteen-seater may include a larger Ford′ Transit van. The vehicle delivery module 214 may transmit the rental information to the server computing device 104.

The server computing device 104 may tentatively determine that there is an appropriate vehicle for the rental and confirm that the vehicle 110 is available during the rental period. The server computing device 104 may transmit a confirmation to the client computing device 102 that indicates that there is a vehicle 110 available during the rental period.

When the vehicle 110 is to be delivered, e.g., a particular number of hours/days before the rental period, the vehicle delivery module 214 may receive another message from the server computing device 104 that confirms that the vehicle will be delivered to the requested location. The client computing device 102 may display a notification on the display 220 that provides the reminder that the vehicle will be delivered to the user at the requested location, which may be the current location of the user. At this time, the user may interact with the notification to view information about the upcoming reservation, such as the vehicle 110 to be delivered, information about the third party provider that will be delivering the vehicle, the location of the delivery, and the estimated time window of the delivery. In addition, the user may be given the opportunity to cancel the reservation or modify the reservation.

The vehicle delivery application 108A further includes a vehicle return request module 216 for sending a vehicle rental return request to the server computing device 104. When the rental period is over or approaching the end, the vehicle return request module 216 may send a message to the server computing device 104 that provides a current location of the vehicle 110, a current fuel/energy level of the vehicle 110, and other information. In one example, the vehicle 110 may transmit the current fuel/energy level to the server computing device 104. In another example, the current fuel/energy level may be transmitted to the client computing device 102 by the vehicle 110 and the client computing device 102 may send the current fuel/energy level to the server computing device 104.

Alternatively, the user may end the rental early and may send the message to the server computing device 104 that provides the current location of the vehicle 110, a current fuel/energy level of the vehicle 110, and other information. The server computing device 104 may receive the message and may dispatch a third party provider to obtain the vehicle 110 from the current location. Alternatively, if the vehicle 110 is an autonomous vehicle, the server computing device 104 may send a message to the vehicle 110 and the vehicle may travel to a particular parking location or a location associated with a next rental reservation.

The vehicle delivery application 108A further includes a user interface module 218 for displaying a user interface on the display 220. As an example, the user interface module 218 generates a native and/or web-based graphical user interface (GUI) that accepts input and provides output viewed by users of the client computing device 102. The client computing device 102 may provide realtime automatically and dynamically refreshed vehicle delivery information. The user interface module 218 may send data to other modules of the vehicle delivery application 108A of the client computing device 102, and retrieve data from other modules of the vehicle delivery application 108A of the client computing device 102 asynchronously without interfering with the display and behavior of the user interface displayed by the client computing device 102.

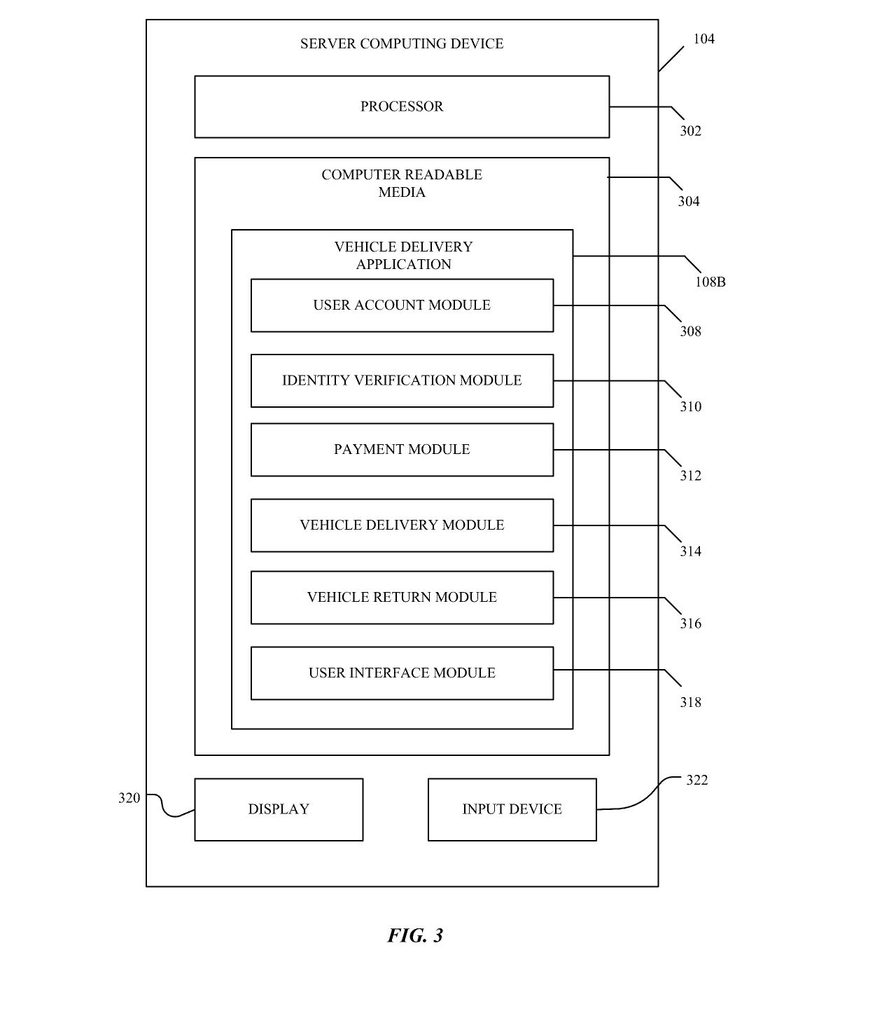

FIG. 3 illustrates a block diagram of the server computing device 104 according to an example embodiment. The server computing device 104 may be a computer having a processor 302 and memory, such as a server, laptop, desktop, tablet computer, mobile computing device (e.g., a smartphone), or a dedicated electronic device having a processor and memory. The one or more processors 302 process machine/computer-readable executable instructions and data, and the memory stores machine/computer-readable executable instructions and data including one or more applications, including a server component of the vehicle delivery application 108B. The processor 302 and memory are hardware. The memory includes random access memory (RAM) and non-transitory memory, e.g., a non-transitory computer-readable storage medium such as one or more flash storages or hard drives. The non-transitory memory may include any tangible computer-readable medium including, for example, magnetic and/or optical disks, flash drives, and the like. Additionally, the memory may also include a dedicated file server having one or more dedicated processors, random access memory (RAM), a Redundant Array of Inexpensive/Independent Disks (RAID) hard drive configuration, and an Ethernet interface or other communication interface, among other components.

The server computing device 104 may include an optional display 320 and an optional input device 322. The display 320 displays visual components of the server component of the vehicle delivery application 108B, such as at a user interface, if applicable. The display 320 can include a cathode-ray tube display, a liquid crystal display, a light-emitting diode display, a touch screen display, and/or other displays. The input device 322 is used to interact with the server component of the vehicle delivery application 108B and may include a mouse, a keyboard, a trackpad, and/or the like. The input device 322 may be included within the display 320 if the display is a touch screen display. The input device 322 allows a user of the server computing device 104 to manipulate the user interface of the vehicle delivery application 108B and make adjustments to the vehicle delivery application 108B.

The server computing device 104 includes computer readable media (CRM) 304 in memory on which the server component of the vehicle delivery application 108B is stored. The computer readable media 304 may include volatile media, nonvolatile media, removable media, non-removable media, and/or another available medium that can be accessed by the processor 302. By way of example and not limitation, the computer readable media 304 comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

The vehicle delivery application 108B includes a user account module 308 for receiving, storing, verifying, and resetting information associated with accounts for using the vehicle delivery system 100. The information associated with the accounts may include username and password information, address information, payment information, and contact information, among other information. When a user, including renters and third party providers that deliver vehicles to renters, first use the vehicle delivery application 108B, the user is asked to create a user account. The user may input a username such as an email address and a password, among other information, and transmit this information to the vehicle delivery application 108B. The user account module 308 stores a representation of this information in the database 106. After the user account is created, when the client computing device 102 opens the vehicle delivery application 108A, a representation of the username and a representation of the password may be transmitted to the server computing device 104. The server computing device 104 verifies the username and password upon receipt and determines whether the user is an authorized user of the vehicle delivery application 108B. If the user is not an authorized user, then they may be denied further access to the vehicle delivery application 108B.

The user account module 308 may provide an interface for resetting password information associated with a particular user account. If a user is unable to provide a correct password or other authentication information after a particular number of incorrect attempts or the password or other authentication information is unknown, the user account module 308 may send a “Forgot Password” message to the vehicle delivery application 108A and display a “Forgot Password” user interface. The user may submit a request that the server computing device 104 reset the password associated with the user account and send an email to an email address associated with the user account including a one-time use URL that when selected, displays a web-based user interface allowing the user to reset their password and create a new password for use with the user account. The user account module 308 also may reset the password in other ways.

In addition, over time the user account module 308 may store history information associated with each vehicle rental reservation including a vehicle 110 rented for the vehicle rental reservation, date/time of the vehicle rental reservation, a vehicle delivery location, a vehicle delivery location, mileage driven, information associated with where the vehicle traveled during the vehicle rental information that may be displayed on a map, velocity of the vehicle during the vehicle rental reservation, and a cost of the rental, among other information. The user account module 308 may use this history information to provide vehicle rental recommendations for users.

The vehicle delivery application 108B additionally includes an identity verification module 310 to verify the identity of users including renters and third party providers that deliver vehicles 110 and pick up vehicles 110. Before a user is able to rent a vehicle 110, the identity verification module 310 verifies the identity of the user using the identity information including the first name, the last name, the physical address, the identification number such as the social security number or driver's license number, and the driver's license information, among other information. The identity information may be obtained from photographs of the driver's license transmitted from the client computing device 102. For example, the identity verification module 310 may determine the first name, the last name, the physical address, the driver's license number, and a photograph of the user by performing image analysis including optical character recognition on the front photograph of the driver's license and the back photograph of the driver's license. The identity verification module 310 may perform verification using a machine learning model that may be trained with previous user data and each user and/or each vehicle rental reservation may be assigned a fraud score. For users having a fraud score greater than a particular fraud score, the user may experience an additional advanced screening process and/or the vehicle rental reservation may be cancelled.

The machine learning model may be based on a Naïve Bayes classifier that utilizes a large feature set input. The features may include the identity information collected from the vehicle delivery application 108A, user actions associated with the vehicle delivery application 108A, and other information obtained from network resources such as other server computing devices that may provide a web API (application programming interface).

The identity verification module 310 may determine the fraud score for each user and/or vehicle rental reservation based on features including a time of a reservation, a total reservation duration, a type of payment method used, a type of client computing device, vehicle rental reservation selection patterns, a value of the vehicle to be rented, information associated with previous vehicle rentals using the vehicle delivery system 110 such as transaction success/failure information, vehicle velocity information during previous vehicle rental reservations, vehicle acceleration information during previous vehicle rental reservations, geolocation information based on the internet protocol (IP) address of the client computing device 102, distance of the user from the selected vehicle delivery location, amount of time the user has used the vehicle delivery system 100 (e.g., one year, one day), feedback from other users of the vehicle delivery system 100 such as feedback from owners of the vehicles previously rented by the user, an online presence for the user, consistency between the identity information and information obtained from the other server computing devices, credit report information for the user from the other server computing devices, social network information for the user obtained from the other server computing devices, an account status for the user (e.g., the user has been previously suspended), and other information.

The vehicle delivery application 108B further includes a payment module 312 for receiving payments from users for vehicle rental reservations and processing the payments. In one example, a user may transmit payment information to the server computing device 104. The payment module 312 may receive the payment information and store a representation of the payment information in the database 106. The payment module 312 may process payments associated with rental reservations using the payment information when rentals are complete and may use the payment information to pre-authorize a transaction associated with a rental reservation. In addition, the payment module 312 may transmit the payment information to a third-party payment processor to process the payments associated with the rental reservations.

The vehicle delivery application 108B includes a vehicle delivery module 314 for receiving a request for a vehicle 110 from a user and determining a particular vehicle to source for the user. The vehicle delivery module 314 receives the rental information about a particular upcoming rental reservation including the vehicle delivery location, the rental start date/time, the rental end date/time, and the requested vehicle type. Upon receipt of the request and until the start date/time, the vehicle delivery module 314 may continue to determine a most suitable vehicle, or appropriate vehicle, for the vehicle request based on a current status of the plurality of vehicles 110 including a particular vehicle type, a location for the vehicle delivery (e.g., a location of the request location (destination)), locations of available vehicles (origins)), traffic information, fuel/energy information for each vehicle, availability information for each vehicle based on other reservation requests, and a time to deliver the vehicle to the vehicle delivery location from the location of the vehicle. The most cost effective vehicle is determined as the most suitable vehicle. Alternatively, a different vehicle may be determined as the most suitable vehicle based on the current status of the plurality of vehicles, user preferences, and/or other factors. The vehicle delivery module 314 may first attempt to provide the requested vehicle type unless there are no available vehicles having the requested vehicle type. In that case, the vehicle delivery module 314 may select a next most suitable vehicle based on the factors provided above.

The most suitable vehicle may be sourced for delivery to the user to arrive at the location as requested by the user at the rental start date/time. In a first example, the server computing device 104 may send a message to a client computing device of a third party provider that is to deliver the vehicle 110 to the user at the rental start date/time. The server computing device 104 may send the message at an appropriate time that allows the third party provider enough time to deliver the vehicle to the user based on traffic and other factors including whether the vehicle 110 may have to be refueled/recharged, washed, and/or inspected for other reasons. The client computing device of the third party provider may be provided with routing information to deliver the vehicle 110 to the user at the rental start date/time. Alternatively, in a second example, the server computing device 104 may send a message to the vehicle 110 with routing information to deliver the vehicle to the user at the rental start date/time. If the vehicle 110 is an autonomous vehicle, the vehicle may travel to the vehicle delivery location to arrive at the rental start date/time. Once the vehicle 110 is in route to the user, the vehicle delivery module 314 determines an estimated time for arrival and sends information associated with the estimated time for arrival to the client computing device 102.

When third party providers are “on duty,” they may be available to deliver vehicles 110 to users and obtain/pickup vehicles 110 from users. Third party providers may include employees of companies/entities that own and rent the vehicles 110 and may include individual owners of the vehicles 110. Each third party provider may be dispatched by the vehicle delivery application 108B. The vehicle delivery application 108B may send a message to the client computing device 102 of the third party provider that provides information about the vehicle delivery or vehicle return. When dispatched, the third party provider may collect a vehicle 110 from a particular parking location and proceed to deliver the vehicle to the requested location, e.g., the location of the user. In one embodiment, the vehicle 110 may have keyless entry hardware and the third party provider may access the vehicle using the client computing device 102. The third party provider may have a modified version of the vehicle delivery application 108A that allows the user to sign a contract upon receipt of the vehicle and when returning the vehicle, manage vehicle damage inspections, review user information, make adjustments to user preferences, open and close reservations, input fuel/energy information and mileage information, and track a user location for vehicle pickup based on a location of the user's client computing device 102.

The vehicle delivery application 108B includes a vehicle return module 316 for receiving a request to return a vehicle 110 from a user and processing the return of the vehicle 110. When the rental period is over and/or before the rental period is over, the vehicle return request module 316 may send a message to the client computing device 102 and/or the vehicle 110 to obtain a current location of the vehicle 110, a current fuel/energy level of the vehicle 110, and other information. Alternatively, if the user requests to end the rental period early, the vehicle return request module 316 may send the message to the client computing device 102 and/or the vehicle 110 obtain the current location of the vehicle, a current fuel/energy level of the vehicle, and other information. The server computing device 104 may receive the location of the vehicle 110 and may dispatch a third party provider to obtain the vehicle from the current location. Alternatively, if the vehicle 110 is an autonomous vehicle, the server computing device 104 may send a message to the vehicle and the vehicle may travel to a particular parking location if there are no upcoming reservations within a particular distance, or the vehicle 110 may be sent to another user for an upcoming reservation if the delivery location for the upcoming reservation is within the particular distance.

When the vehicle 110 arrives at the vehicle return location, e.g., the particular parking location, the vehicle return module 316 may send a notification or message to the client computing device 102 indicating that the vehicle has arrived at the vehicle return location and providing a final total price for the rental reservation that may include any additional charges. The vehicle return location may be based on at least one of at least one upcoming vehicle delivery request, traffic information, and fuel/energy information.

The vehicle delivery application 108B includes a user interface module 318. The user interface module 318 receives requests or other communications from the client computing devices 102 and transmits a representation of requested information, user interface elements, and other data and communications to the client computing device 102 for display on the display 220. As an example, the user interface module 318 generates a native and/or web-based graphical user interface (GUI) that accepts input and provides output by generating content that is transmitted via the communications network 112 and viewed by a user of the client computing device 102. The user interface module 318 may provide realtime automatically and dynamically refreshed information to the user of the client computing device 102 using Java, Javascript, AJAX (Asynchronous Javascript and XML), ASP.NET, Microsoft .NET, and/or node.js, among others. The user interface module 318 may send data to other modules of the vehicle delivery application 108B of the server computing device 104, and retrieve data from other modules of the vehicle delivery application 108B of the server computing device 104 asynchronously without interfering with the display and behavior of the vehicle delivery application 108A displayed by the client computing device 102. As an example, data may be retrieved using XMLHttpRequest objects or using WebSockets.

The vehicle 110 may include a computer having a processor and memory, or a dedicated electronic device having a processor and memory. The one or more processors process machine/computer-readable executable instructions and data, and the memory stores machine/computer-readable executable instructions and data including one or more applications, including components that may communicate with the vehicle delivery application 108A/108B. The processor and memory are hardware. The memory includes random access memory (RAM) and non-transitory memory, e.g., a non-transitory computer-readable storage medium such as one or more flash storages or hard drives. The non-transitory memory may include any tangible computer-readable medium including, for example, magnetic and/or optical disks, flash drives, and the like. Additionally, the memory may also include a dedicated file server having one or more dedicated processors, random access memory (RAM), a Redundant Array of Inexpensive/Independent Disks (RAID) hard drive configuration, and an Ethernet interface or other communication interface, among other components.

The vehicle 110 may be autonomous or partially autonomous. For example, the vehicle 110 may operate without a driver while in an autonomous mode and may determine a current state of the vehicle and its environment, determine predicted behavior of at least one other vehicle in the environment, determine obstacles in the environment including pedestrians, animals, and other objects, and control the vehicle 110.

Additionally, the vehicle 110 may include subsystems such as a sensor system, a control system, a propulsion system, a communication system, a power supply, a user interface display, and other systems. In one example, the vehicle 110 may communicate with the client computing device 102 and/or the server computing device 104. The vehicle 110 may connect with the client computing device 102 using the communications network 112 and/or may connect using Bluetooth®. These subsystems may be interconnected via a bus or another connector. The propulsion system may include components to provide powered motion for the vehicle 110. The propulsion system may include an engine and/or a motor. The engine and/or the motor may include an internal combustion engine, an electric motor, a steam engine, a Stirling engine, or other types of engines and/or motors.

In one example, the vehicle 110 may receive location information including a delivery location or a return location from the server computing device 104 and determine a particular route to the delivery location or the return location. If the vehicle is an autonomous vehicle or a partially autonomous vehicle, the vehicle 110 may travel to the delivery location or the return location.

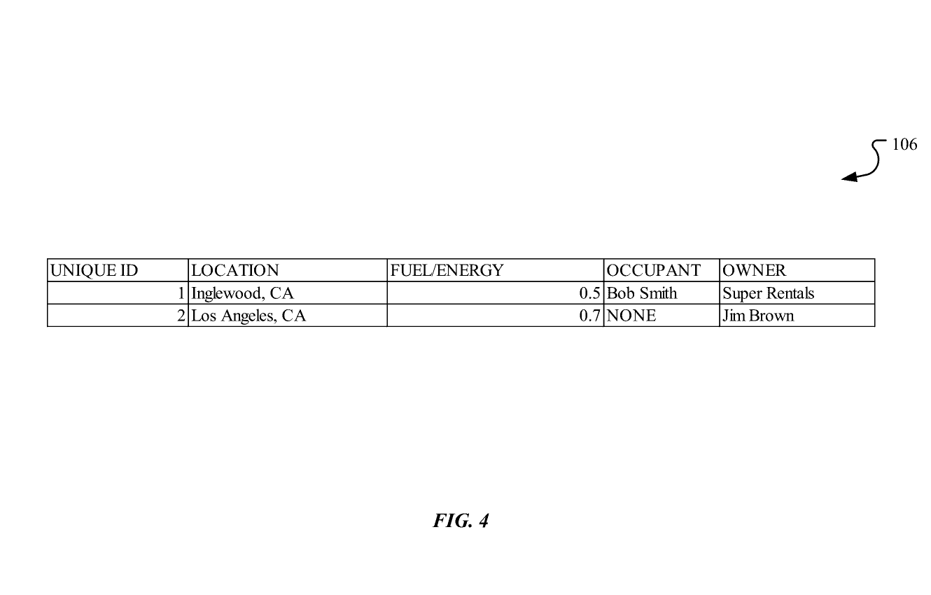

FIG. 4 illustrates an example table of the database 106 of the vehicle delivery system 100 according to an example embodiment. As shown in FIG. 4, each row of the table may store information regarding a vehicle 110 of the vehicle delivery system 100. FIG. 4 shows that the database 106 may store a unique identifier (ID) that represents each vehicle 110, a current location of each vehicle 110, a current fuel/energy level for each vehicle 110, a current occupant/user for each vehicle 110, and owner information associated with each vehicle 110. Other information may be stored in the database 106 such as user account information including username information, password information, contact information (e.g., an email address), and payment information.

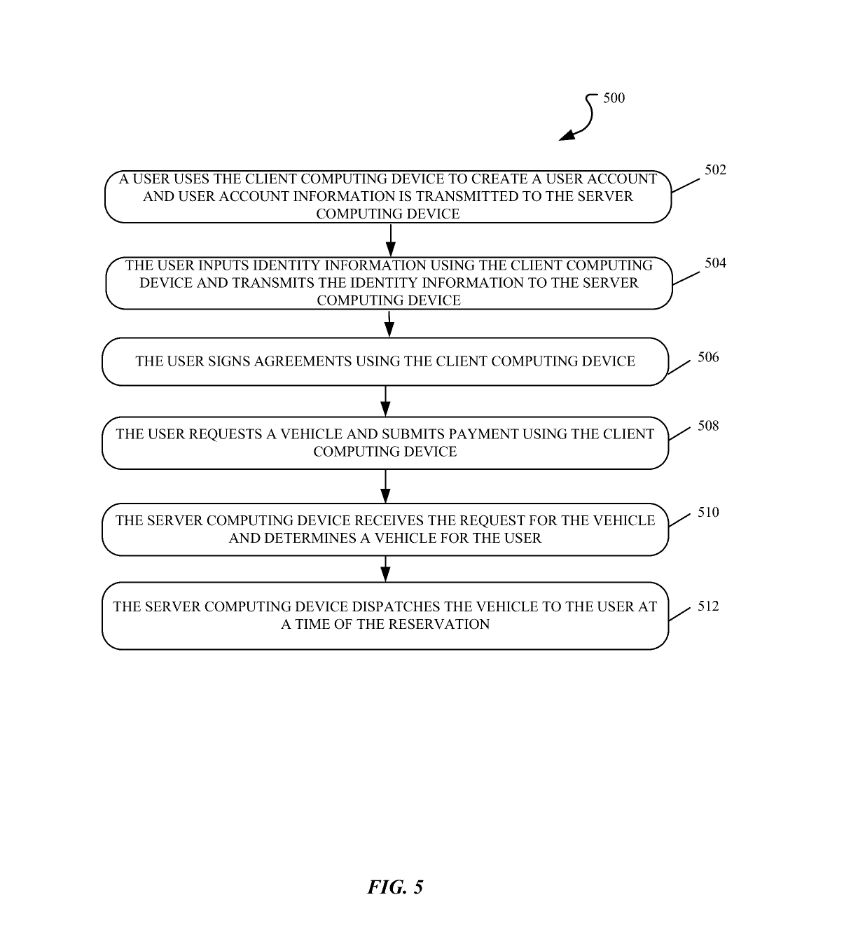

FIG. 5 illustrates a flowchart of a process 500 executed by the vehicle delivery application 108A of the client computing device 102 and the vehicle delivery application 108B of the server computing device 104 for delivering a vehicle 110 to a user, e.g., a renter. The process 500 shown in FIG. 5 begins at 502.

At 502, a user, e.g., the renter, uses the vehicle delivery application 108A of the client computing device 102 to create a user account. The user may input user account information including username information, password information, and contact information to a user interface of the vehicle delivery application 108A. The client computing device 102 transmits the user account information to the server computing device 104. The server computing device 104 stores a representation of the user account information in the database 106.

At 504, the user inputs identity information to a user interface of the vehicle delivery application 108A. The user may enter information such as a first name, a last name, a physical address, driver's license information, and other information such as a social security number or other identifying information. The client computing device 102 transmits the identity information to the server computing device 104. The server computing device 104 uses the identity information to verify an identity of the user.

As an example, the client computing device 102 may capture a first photograph of a front of a driver's license and transmit the first photograph to the server computing device 104. The client computing device 102 also may capture a second photograph of a back of a driver's license and transmit the second photograph to the server computing device 104. The server computing device 104 may perform image analysis on the first photograph of the driver's license and the second photograph of the driver's license to determine identity information including a name, a physical address, and a driver's license identification number based on the image analysis. The server computing device 104 may determine the fraud score based on the identity information and/or and transmit the identity information to another server computing device to obtain a fraud score for the user. In one example, the client computing device 102 may receive a representation of the fraud score transmitted by the server computing device 104 that may indicate whether the user is permitted to rent a selected vehicle 110 for a particular rental reservation. This representation of the fraud score may be indicated on the display 220 of the client computing device 102.

At 506, the user signs agreements using a user interface of the vehicle delivery application 108A. In one example, the user may sign a contract agreeing that all identity information is correct and to pay for the rental of vehicles using the vehicle delivery application 108A. The vehicle delivery application 108A may capture signature information and transmit the signature information to the server computing device 104 for storage in the database 106.

At 508, the user inputs vehicle rental reservation information to the client computing device 102 including a time period for the vehicle rental reservation, a vehicle delivery location, and a desired vehicle using the user interface of the vehicle delivery application 108A. The client computing device 102 transmits the particular date, a time period, the delivery location, and a desired vehicle to the server computing device 104. The server computing device 104 confirms that the desired vehicle is available when requested and the user may pay for the vehicle rental reservation and/or provide a deposit for the vehicle 110. The client computing device 102 may transmit payment information to the server computing device 104 or another server computing device.

At 510, the server computing device 104 receives the payment information from the client computing device 102 and stores the vehicle rental information in the database 106. The server computing device 104 initially determines a particular vehicle for the user and stores the particular vehicle, e.g., a Toyota® Corolla located at a particular location, with the vehicle rental information in the database 106. Upon receipt of the request and until the start date/time, the vehicle delivery module 314 may continue to determine a most suitable vehicle for the vehicle request based on a current status of the plurality of vehicles 110 including a location of each vehicle, traffic information, fuel/energy information for each vehicle, availability information for each vehicle, and a time to deliver the vehicle to the vehicle delivery location from the location of the vehicle. The most cost effective vehicle is determined as the most suitable vehicle. Alternatively, a different vehicle may be determined as the most suitable vehicle based on the current status of the plurality of vehicles.

At 512, the server computing device 104 dispatches a third party provider to drive the particular vehicle to a location for the user or may dispatch the vehicle 110 to the location for the user if the vehicle is an autonomous vehicle. The vehicle 110 that is sent to the user may be the most cost effective vehicle based on the location of the vehicle, traffic information at the time of dispatch, fuel/energy information, availability information for each vehicle, and the time to deliver the vehicle to the delivery location. The server computing device 104 may send a message that includes information about delivery of the vehicle 110 to the user including realtime tracking information about a location of the vehicle, and other information about the vehicle delivery such as a name/photograph for the third party provider that will deliver the vehicle to the user.

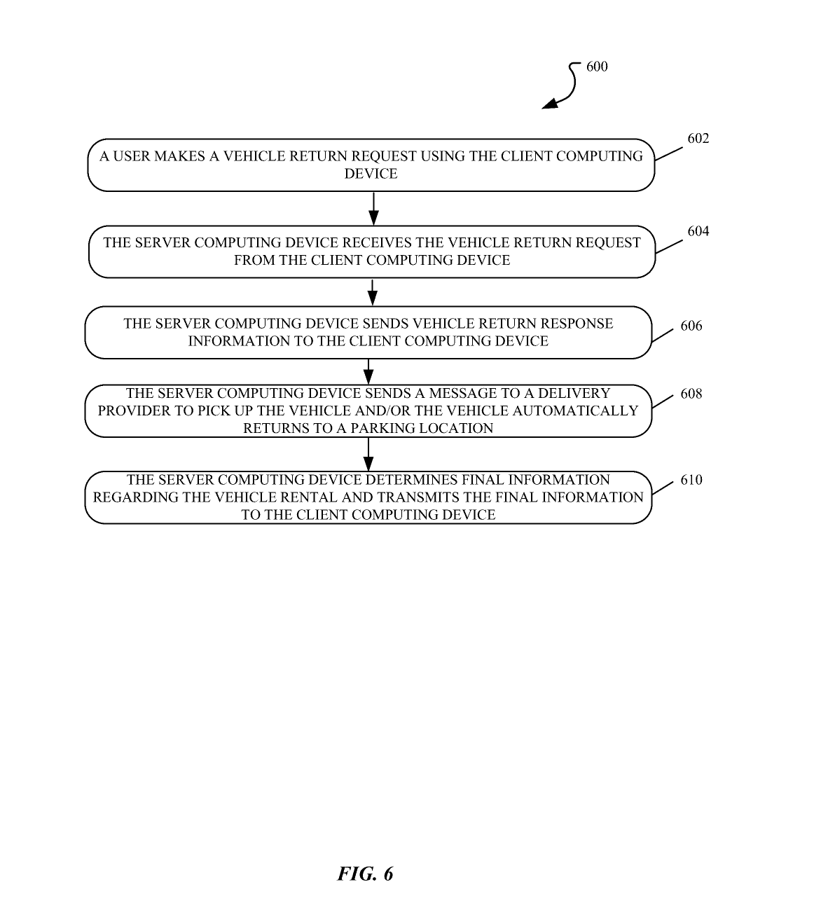

FIG. 6 illustrates a flowchart of a process 600 executed by the vehicle delivery application 108A of the client computing device 102 and the vehicle delivery application 108B of the server computing device 104 for returning a vehicle 110 to a particular parking location, such as a parking lot or garage. Alternatively, the vehicle 110 may be sent to a next rental user for the next rental reservation. The process 600 shown in FIG. 6 begins at 602.

At 602, a user, e.g., the renter, uses the vehicle delivery application 108A of the client computing device 102 to submit a vehicle return request. The client computing device 102 transmits a current location of the client computing device 102 and/or the vehicle 110 to the server computing device 104. Alternatively, the client computing device 102 and/or the vehicle 110 may send a message to the server computing device 104 when an associated rental reservation is nearing the end to allow enough time for the vehicle 110 to be returned to a particular parking location or delivered to a next recipient.

At 604, the server computing device 104 receives the vehicle return request from the client computing device 102 and the vehicle delivery application 108B stores vehicle return request information in the database 106. This may include information obtained from the client computing device 102 and/or the vehicle 110 including a current location of the vehicle, fuel/energy information, mileage information, and a rental end date/time.

At 606, the server computing device 104 confirms that the vehicle return request is received by the server computing device 104. The server computing device 104 sends a message including confirmation information to the client computing device 102. The confirmation information may include a tentative pick up time or pickup window and other information about the vehicle pick up such as a name/photograph for the third party provider that will pick up the vehicle from the user.

At 608, the server computing device 104 sends a message to a third party provider, e.g., an employee, with vehicle return information including the location of the vehicle 110, the particular parking location or next destination, and information about the vehicle 110 such as a vehicle manufacturer, a vehicle model, a vehicle color, and other information. Alternatively, the server computing device 104 may send the message with the particular parking location or the next destination to the vehicle 110 if the vehicle is an autonomous vehicle. If the vehicle 110 is an autonomous vehicle, the vehicle may route to travel to the particular parking location or the next destination.

At 610, when the vehicle rental reservation is over and the vehicle 110 is in the process of being returned to a particular parking location or sent to a next user for another rental reservation, the vehicle delivery application 108B may determine final information regarding the rental of the vehicle and transmit the final information to the client computing device 102. The final information may include a duration of the rental, miles traveled during the rental, fuel/energy consumed during the rental, and a final price of the rental.

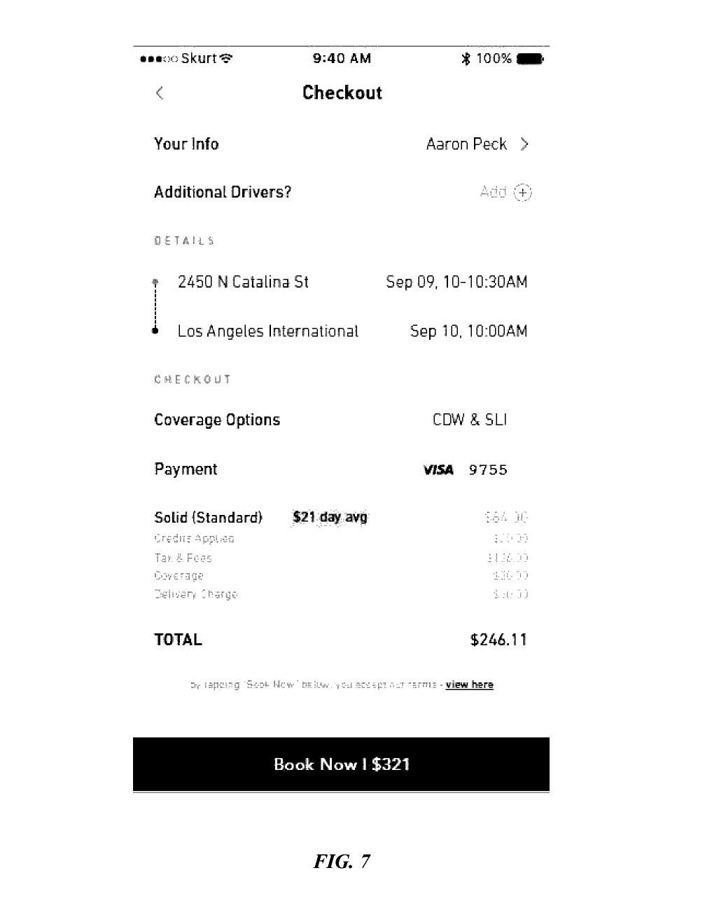

FIG. 7 shows a screenshot of a user interface of the vehicle delivery application 108A displayed on the display 220 of the client computing device 102. The screenshot shown in FIG. 7 is a user interface associated with the checkout process for accepting the terms associated with a vehicle delivery and rental. As shown in the screenshot, the vehicle 110 may be delivered to a particular location, e.g., 2450 N Catalina St, and the rental period may begin on September 9 at 10-10:30 am and end on September 10 at 10:00 am. The vehicle type is a “Solid.” There is a credit card payment method shown, e.g., Visa, an estimated rental total, and a user interface element, e.g., a Book Now button, which allows the user to accept the rental.

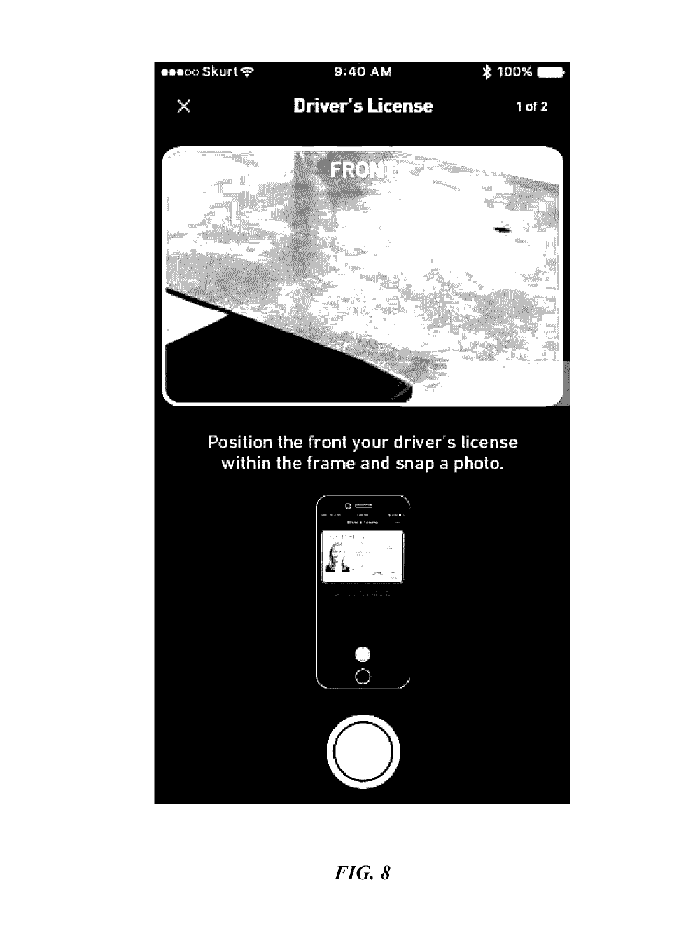

FIG. 8 shows a screenshot of a user interface of the vehicle delivery application 108A displayed on the display 220 of the client computing device 102. The screenshot in FIG. 8 is a user interface associated with capturing images of a front of a driver's license or another type of identification.

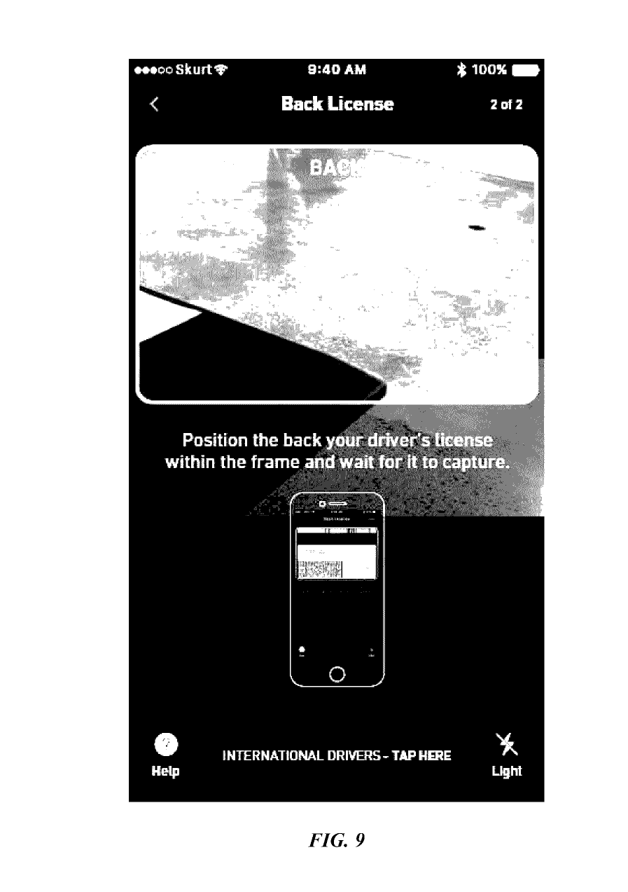

FIG. 9 shows a screenshot of a user interface of the vehicle delivery application 108A displayed on the display 220 of the client computing device 102. The screenshot in FIG. 9 is a user interface associated with capturing images of a back of a driver's license or another type of identification.

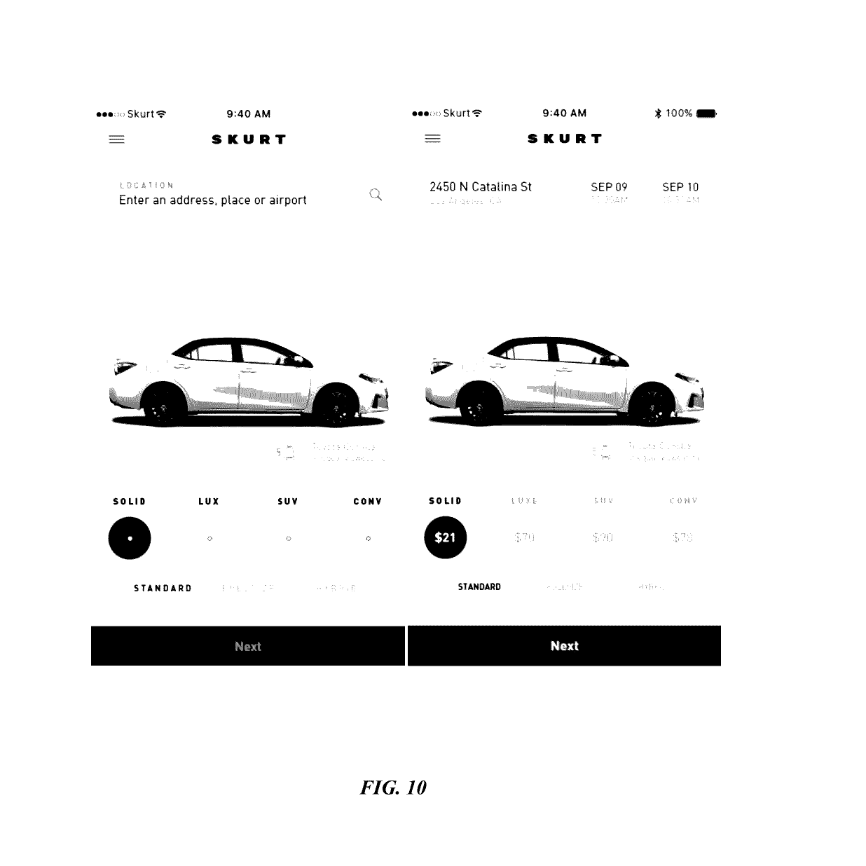

FIG. 10 shows multiple screenshots of user interfaces of the vehicle delivery application 108A displayed on the display of the client computing device 102. The screenshots in FIG. 10 are user interfaces associated with selecting a location for vehicle delivery, a rental start date/time, a rental end date/time, and a vehicle type or class.

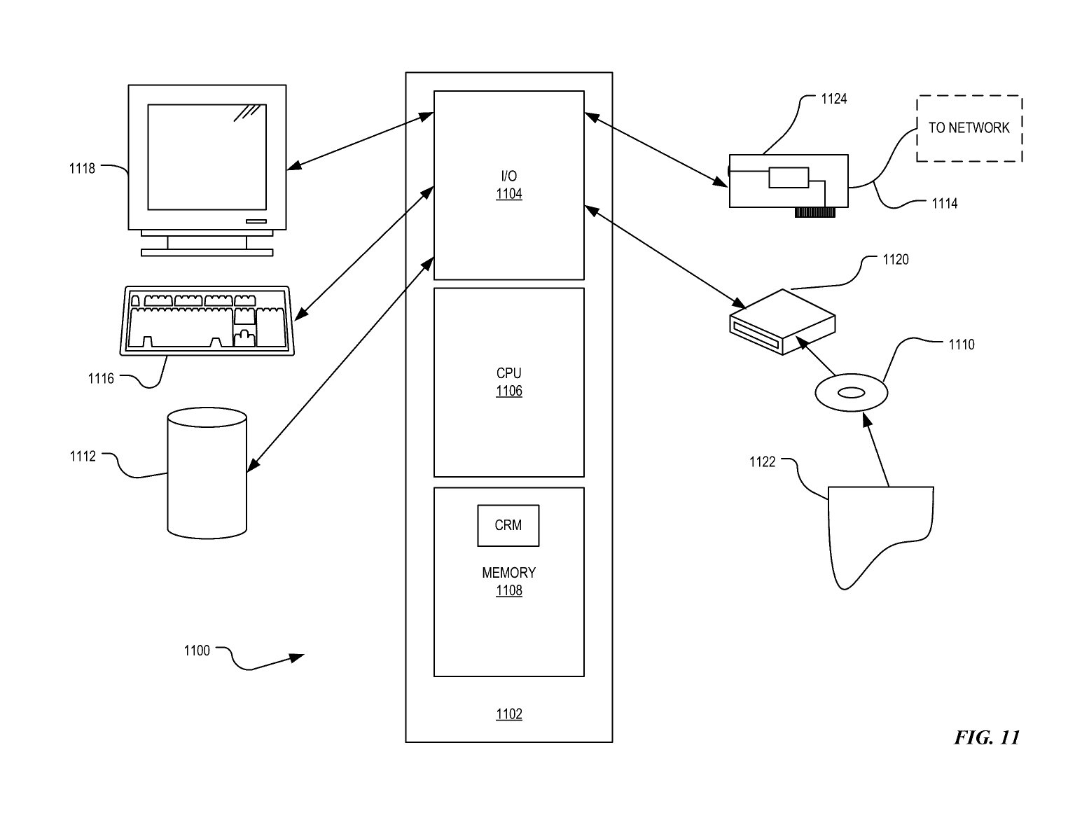

FIG. 11 illustrates an example computing system 1100 that may implement various systems, such as the client computing device 102, the server computing device 104, the vehicle, and the methods discussed herein, such as processes 500 and 600. A general purpose computer system 1100 is capable of executing a computer program product to execute a computer process. Data and program files may be input to the computer system 1100, which reads the files and executes the programs therein such as the client component of the vehicle delivery application 108A and the server component of the vehicle delivery application 108B. Some of the elements of a general purpose computer system 1100 are shown in FIG. 11 wherein a processor 1102 is shown having an input/output (I/O) section 1104, a central processing unit (CPU) 1106, and a memory section 1108. There may be one or more processors 1102, such that the processor 1102 of the computer system 1100 comprises a single central-processing unit 1106, or a plurality of processing units, commonly referred to as a parallel processing environment. The computer system 1100 may be a conventional computer, a server, a distributed computer, or any other type of computer, such as one or more external computers made available via a cloud computing architecture. The presently described technology is optionally implemented in software devices loaded in memory 1108, stored on a configured DVD/CD-ROM 1110 or storage unit 1112, and/or communicated via a wired or wireless network link 1114, thereby transforming the computer system 1100 in FIG. 11 to a special purpose machine for implementing the described operations.

The memory section 1108 may be volatile media, nonvolatile media, removable media, non-removable media, and/or other media or mediums that can be accessed by a general purpose or special purpose computing device. For example, the memory section 1108 may include non-transitory computer storage media and communication media. Non-transitory computer storage media further may include volatile, nonvolatile, removable, and/or non-removable media implemented in a method or technology for the storage (and retrieval) of information, such as computer/machine-readable/executable instructions, data and data structures, engines, program modules, and/or other data. Communication media may, for example, embody computer/machine-readable/executable, data structures, program modules, algorithms, and/or other data. The communication media may also include an information delivery technology. The communication media may include wired and/or wireless connections and technologies and be used to transmit and/or receive wired and/or wireless communications.

The I/O section 1104 is connected to one or more user-interface devices (e.g., a keyboard 1116 and a display unit 1118), a disc storage unit 1112, and a disc drive unit 1120. Generally, the disc drive unit 1120 is a DVD/CD-ROM drive unit capable of reading the DVD/CD-ROM medium 1110, which typically contains programs and data 1122. Computer program products containing mechanisms to effectuate the systems and methods in accordance with the presently described technology may reside in the memory section 1104, on a disc storage unit 1112, on the DVD/CD-ROM medium 1110 of the computer system 1100, or on external storage devices made available via a cloud computing architecture with such computer program products, including one or more database management products, web server products, application server products, and/or other additional software components. Alternatively, a disc drive unit 1120 may be replaced or supplemented by a floppy drive unit, a tape drive unit, or other storage medium drive unit. The network adapter 1124 is capable of connecting the computer system 1100 to a network via the network link 1114, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 1100 is connected (by wired connection and/or wirelessly) to a local network through the network interface or adapter 1124, which is one type of communications device. When used in a WAN-networking environment, the computer system 1100 typically includes a modem, a network adapter, or any other type of communications device for establishing communications over the wide area network. In a networked environment, program modules depicted relative to the computer system 1100 or portions thereof, may be stored in a remote memory storage device. It is appreciated that the network connections shown are examples of communications devices for and other means of establishing a communications link between the computers may be used.

In an example implementation, source code executed by the client computing device 102, the server computing device 104, the vehicle 110, a plurality of internal and external databases, source databases, and/or cached data on servers are stored in the database 106, memory of the client computing device 102, memory of the server computing device 104, memory of the vehicle, or other storage systems, such as the disk storage unit 1112 or the DVD/CD-ROM medium 1110, and/or other external storage devices made available and accessible via a network architecture. The source code executed by the client computing device 102, the server computing device 104, and the vehicle 110 may be embodied by instructions stored on such storage systems and executed by the processor 1102.

Some or all of the operations described herein may be performed by the processor 1102, which is hardware. Further, local computing systems, remote data sources and/or services, and other associated logic represent firmware, hardware, and/or software configured to control operations of the vehicle delivery system 100 and/or other components. Such services may be implemented using a general purpose computer and specialized software (such as a server executing service software), a special purpose computing system and specialized software (such as a mobile device or network appliance executing service software), or other computing configurations. In addition, one or more functionalities disclosed herein may be generated by the processor 1102 and a user may interact with a Graphical User Interface (GUI) using one or more user-interface devices (e.g., the keyboard 1116, the display unit 1118, and the user devices 1104) with some of the data in use directly coming from online sources and data stores. The system set forth in FIG. 11 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon executable instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic executable instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system comprising:
at least one processor to:
receive a vehicle reservation request comprising a vehicle delivery location, a start time, an end time, and a vehicle type from a mobile computing device;
determine an appropriate vehicle for the vehicle reservation request from a plurality of vehicles, the appropriate vehicle selected based on a location of each of the plurality of the vehicles, the vehicle delivery location, a current fuel/energy level for each of the plurality of vehicles, an availability of each of the plurality of vehicles having the vehicle type between the start time and the end time, and traffic information; and
dispatch the appropriate vehicle to arrive at the vehicle delivery location at the start time.

2. The system of claim 1, the at least one processor further to:
receive identity information for a user of the appropriate vehicle;
determine a fraud score for the user based on the identity information; and
cancel the vehicle reservation request based on the fraud score.

3. The system of claim 1, the at least one processor further to:
receive a photograph of a driver's license from the mobile computing device;
perform image analysis on the driver's license to determine identity information for a user of the appropriate vehicle; and
determine a fraud score for the user based on the identity information.

4. The system of claim 1, the at least one processor further to:
receive a first photograph of a front of a driver's license from the mobile computing device;
receive a second photograph of a back of a driver's license from the mobile computing device;
perform image analysis on the first photograph of the driver's license and the second photograph of the driver's license to determine identity information including a name, a physical address, and a driver's license identification number of a user for the appropriate vehicle based on the image analysis;
transmit the identity information to a server computing device to obtain a fraud score for the user; and
transmit a representation of the fraud score to the mobile computing device.

5. The system of claim 1, the at least one processor further to:
transmit a contractual agreement for the vehicle reservation request to the mobile computing device; and
receive an image from the mobile computing device that represents a signature of the contractual agreement from a user of the appropriate vehicle.

6. The system of claim 1, the at least one processor further to transmit a message to the appropriate vehicle at the end time, the message comprising one of a location of a next reservation request and a parking location for the appropriate vehicle.

7. The system of claim 1, the at least one processor further to:
receive a location of the mobile computing device; and
dispatch the appropriate vehicle to arrive at the location of the mobile computing device at the start time.

8. The system of claim 1, the at least one processor further to transmit realtime tracking information of the appropriate vehicle to the mobile computing device.

9. A method comprising:
receiving, by at least one processor, a vehicle reservation request comprising a vehicle delivery location, a start time, an end time, and a vehicle type from a mobile computing device;
determining, by the at least one processor, an appropriate vehicle for the vehicle reservation request from a plurality of vehicles, the appropriate vehicle selected based on a location of each of the plurality of the vehicles, the vehicle delivery location, a current fuel/energy level for each of the plurality of vehicles, an availability of each of the plurality of vehicles having the vehicle type between the start time and the end time, and traffic information; and
dispatching, by the at least one processor, the appropriate vehicle to arrive at the vehicle delivery location at the start time.

10. The method of claim 9, further comprising:
receiving identity information for a user of the appropriate vehicle;
determining a fraud score for the user based on the identity information; and
cancelling the vehicle reservation request based on the fraud score.

11. The method of claim 9, further comprising:
receiving a photograph of a driver's license from the mobile computing device;
performing image analysis on the driver's license to determine identity information for a user of the appropriate vehicle; and
determining a fraud score for the user based on the identity information.

12. The method of claim 9, further comprising:
receiving a first photograph of a front of a driver's license from the mobile computing device;
receiving a second photograph of a back of a driver's license from the mobile computing device;
performing image analysis on the first photograph of the driver's license and the second photograph of the driver's license to determine identity information including a name, a physical address, and a driver's license identification number of a user for the appropriate vehicle based on the image analysis;
transmitting the identity information to a server computing device to obtain a fraud score for the user; and
transmitting a representation of the fraud score to the mobile computing device.

13. The method of claim 9, further comprising:
transmitting a contractual agreement for the vehicle reservation request to the mobile computing device; and
receiving an image from the mobile computing device that represents a signature of the contractual agreement from a user of the appropriate vehicle.

14. The method of claim 9, further comprising transmitting a message to the appropriate vehicle at the end time, the message comprising one of a location of a next reservation request and a parking location for the appropriate vehicle.

15. The method of claim 9, further comprising:
receiving a location of the mobile computing device; and
dispatching the appropriate vehicle to arrive at the location of the mobile computing device at the start time.

16. The method of claim 9, further comprising transmitting realtime tracking information of the appropriate vehicle to the mobile computing device.

17. A non-transitory computer-readable medium comprising instructions stored thereon that, when executed by at least one processor, causes the at least one processor to perform operations comprising:
receiving a vehicle reservation request comprising a vehicle delivery location, a start time, an end time, and a vehicle type from a mobile computing device;
determining an appropriate vehicle for the vehicle reservation request from a plurality of vehicles, the appropriate vehicle selected based on a location of each of the plurality of the vehicles, the vehicle delivery location, a current fuel/energy level for each of the plurality of vehicles, an availability of each of the plurality of vehicles having the vehicle type between the start time and the end time, and traffic information; and
dispatching the appropriate vehicle to arrive at the vehicle delivery location at the start time.

18. The non-transitory computer-readable medium of claim 17, the operations further comprising:
receiving identity information for a user of the appropriate vehicle;
determining a fraud score for the user based on the identity information; and
cancelling the vehicle reservation request based on the fraud score.

19. The non-transitory computer-readable medium of claim 17, the operations further comprising:
receiving a photograph of a driver's license from the mobile computing device;
performing image analysis on the driver's license to determine identity information for a user of the appropriate vehicle; and
determining a fraud score for the user based on the identity information.

20. The non-transitory computer-readable medium of claim 17, the operations further comprising:
receiving a first photograph of a front of a driver's license from the mobile computing device;
receiving a second photograph of a back of a driver's license from the mobile computing device;
performing image analysis on the first photograph of the driver's license and the second photograph of the driver's license to determine identity information including a name, a physical address, and a driver's license identification number of a user for the appropriate vehicle based on the image analysis;
transmitting the identity information to a server computing device to obtain a fraud score for the user; and
transmitting a representation of the fraud score to the mobile computing device.

21. The non-transitory computer-readable medium of claim 17, the operations further comprising:
transmitting a contractual agreement for the vehicle reservation request; and
receiving an image that represents a signature of the contractual agreement from a user of the appropriate vehicle.

22. The non-transitory computer-readable medium of claim 17, the operations further comprising transmitting a message to the appropriate vehicle at the end time, the message comprising one of a location of a next reservation request and a parking location for the appropriate vehicle.

23. The non-transitory computer-readable medium of claim 17, the operations further comprising:
receiving a location of the mobile computing device; and
dispatching the appropriate vehicle to arrive at the location of the mobile computing device at the start time.

24. The non-transitory computer-readable medium of claim 17, the operations further comprising transmitting realtime tracking information of the appropriate vehicle to the mobile computing device.
